(19) United States
(12) Patent Application Publication
(10) Pub. No.: US 2003/0157381 A1
(43) Pub. Date: Aug. 21, 2003

(54) Polymer electrolyte fuel cell based heat and power generation unit

(76) Inventors: Eleonoor Van Andel, Bockelo (NL); Erik Middelman, Arnhem (NL)

Correspondence Address: Oliff & Berridge, PO Box 19928, Alexanria, VA, 22320, US

(21) Appl. No.: 10/203,929

(22) PCT Filed: Feb. 19, 2001
(86) PCT No.: PCT/NL01/00135

(30) Foreign Application Priority Data
Feb. 17, 2000 (NL) 1014400

(51) Int. Cl. H01M 8/06; H01M 8/10; H02M 7/00

(52) U.S. Cl. 429/19; 429/32; 363/13

(57) ABSTRACT

The invention is aimed at providing a heat and power generating apparatus comprising a polymer electrolyte fuel cell stack, and a fuel processing system that converts a hydrocarbon into a hydrogen rich mixture, the apparatus according to the invention has a high electrical as well as thermal efficiency. The high efficiency is realized according to the invention by operating the system at atmospheric pressure, low-pressure drop, and by using an efficient inverter.

The invention is aimed at providing a heat and power generating apparatus comprising a polymer electrolyte fuel cell stack, and a fuel processing system that converts a hydrocarbon into a hydrogen rich mixture, the apparatus according to the invention has a high electrical as well as thermal efficiency

Polymer electrolyte fuel cells, or PEM fuel cells are a generally known type of fuel cell as known from publications like: “Fuel cells in perspective and the fifth European framework program” by Gilles Lequeux in proceedings of “The 3^{rd} International Fuel Cell Conference”. Because of its low operating temperature, long life, high power density and potentially low cost, a PEM fuel cell system is a good candidate for conversion of fossil fuel into heat and electric power in small units.

Hydrocarbons can be converted into hydrogen rich gas mixtures. The PEM fuel cell needs hydrogen as fuel, but its catalysts are not resistant against certain Sulphur compounds and for example CO. To avoid poisoning of the fuel cells electro catalyst the fuel, like for example natural gas, butane, LPG etc, has to be cleaned to remove harmful components like Sulphur compounds, and converted into a hydrogen containing gas mixture with less than 100 PPM CO. The conversion of hydrocarbons to hydrogen is done in a so-called reformer or fuel processor. In this reactor fuel and steam are converted at 700° C.-800° into a mixture of H₂, CO, CO₂, H₂O, and in a next reactor CO and steam are converted to CO2 and hydrogen, than the resulting gas mixture passes trough a selective oxidation reactor were the remaining CO is oxidized with a small amount of oxygen to CO2.

The PEM fuel cell generates heat and electrical power. The heat that is generated in the fuel cell stack has to be removed. In order to efficiently use this thermal energy, the heat has to be removed at a useful temperature.

The DC power, can be converted by a grid-connected inverter, and supplied to the grid. The electrical power can also be used directly.

At the cathode of the PEM fuel cell reaction water is formed. At the anode moistened hydrogen containing gas is supplied. Water can condensate and form droplets in the hydrophobic gas channels of conventional PEM fuel cells, and these droplets have to be removed from these channels. A known method of water droplet removal is applying high-pressure drop over these channels and/or by generating pressure pulses. Use of high pressure requires an air compressor, and is there for more expensive than use of a simple fan. Another disadvantage of the method is that the number of water droplets in the channels will not be the same for all channels resulting in a difference in flow between these channels, and also results in reduced gas utilization.

In the reformer a hydrocarbon is converted into a hydrogen rich gas mixture. Reformers are operated at high temperatures up to 1300° C. The hot reformer has to be isolated to reduce heat loss. Existing reformer technology is not able to reduce these heat losses to less than a few hundred Watts, resulting especially for small systems in the range of 1 to 2 kWe to substantial efficiency loss.

Large-scale application of fuel cell based micro cogeneration units will only take place if the price of power generated by the micro cogen becomes competitive with the price of power generated by large-scale central power plants, and if the total efficiency is higher than that of the existing technology.

In the apparatus according to the invention many of the drawbacks of the existing technology are eliminated by a combination of a number of closely related measures.

According to the invention hydrophilic gas distribution channels are used instead of the state of the art hydrophobic channels. These hydrophilic channels are according to the invention connected with a hydrophilic capillary drain, and thus the channels remain free from water droplets without having to apply a high-pressure drop over the gas channels. It was found that the pressure in the capillary drain system must be more than 500 Pa below the gas pressure in the channels in order to properly drain all the reaction water from the channels. This is realised by using structured surfaces that are connected to the gas channels, with a feature size of hundred's of micrometers. The shape of the textured hydrophilic surfaces it self is not important, and can have the form of channels, pyramids, fibres, fabric etc. It is however important that every gas channel in the cell plate is connected to the capillary structure and trough this capillary structure with a water drain. Channels are connected if an uninterrupted water film can exist on the surface of the gas channel as well as on the surface of the capillary structure, and if this connection allows sufficient flow of reaction water. The power required for removal of water with the capillary drain according to the invention is very small, since the volume of water that has to be removed is approximately 1000 times less than the gas flow. The necessary pressure drop over the gas channel is drastically reduced and can be less than 100 Pa depending on the flow, channel dimension and channel length. In a 1 kWe micro cogen system a 1 Watt fan will be sufficient to supply the required amount of air to the fuel cell, thus eliminating the necessity of using air compressors with the associated noise, maintenance, costs and high energy consumption.

To obtain a high system efficiency thermal losses from the reformer have to be minimised and flow resistance has to be reduced as much as possible. Even by using vacuum isolation like a “Dewar vessel”, the thermal losses from the small reformer with a peak temperature between 700° C. and 800° C., will be not less than 200 W for a 1 kW electrical power micro cogen system because. of radiation losses. Heating the feed gasses of the reformer to the peak temperature will cost hundreds of watts if the exhaust gasses leave the reactor at this high temperature. According to the invention these problems are solved by an apparatus in which heating of the feed gasses, an exothermic reforming reactor, a shift reactor, and cooling of the hot reformed gas stream are integrated in counter flow, in such a way that the feed gasses are heated by the exhaust gasses and by the exothermic CPO reaction and/or the exothermic reaction between Carbon Monoxide and oxygen or the exothermic reaction between hydrogen and oxygen, this heat exchanger having the form of a large number of thermal radiation reflectors that are co-heated by the exothermal of the CPO reaction, and the integrated reactor having the form of a multi-blade spiral, having preferably 4 blades, and between these blades the channels for feed gas (hydrocarbon containing gas), an air containing gas mixture, reformed gas and an empty channel. Experiments have shown that heat losses are reduced to approximately 10% compared to a conventional reactor design.

The heat that is required for moistening of the feed gasses of the system is approximately 10% of the total generated heat, and the required temperature level is above that of the fuel cell stack. The necessary steam can be generated by using the heat loss of the reformer at a temperature of approximately 80° C., since it is not possible to do this at that temperature level by using the heat from the fuel cell stack. For moistening preferably a direct contact apparatus is used like a counter flow packed column is used. The hot water flow of this packed flooded column that is cooled by the water evaporating into the gas stream, is reheated by the fuel cell stack, and than heated by the outer shell of the reformer to approximately 80° C. The reformer is designed to generate just enough heat loss to moisten the its own feed gasses. By operating the system at atmospheric pressure it is made possible to evaporate the major part of the water needed for moistening the feed gasses. This significantly increases the systems energy efficiency. The heat needed for moistening the feed gasses is approximately 70% of the total heat produced by the fuel cell stack. Insufficient fuel cell temperature requires extra fuel for steam generation, thus reducing system efficiency.

The heat and power generation system will in general be connected to the grid. The grid can be a small local AC-grid in a house, or the public grid. If power is delivered back to the grid, it is important to minimise conversion losses. Use of transformers for increase of the output voltage will cause power losses of 3-5%. According to the invention this power loss is eliminated by use of a fuel cell stack with a large number of individual cells. The number of cells is chosen such that the DC output voltage of the stack is above the AC peak voltage of the grid. (The peak voltage is defined as 2\hat{ }^{0.5}* the AC voltage. In a 230 Volt AC grid the peak voltage is 2\hat{ }^{0.5}*230=325 Volt.) This eliminates the need for a transformer, and the associated losses. The only remaining losses are the high frequency switching losses. Another advantage is a substantial cost reduction of the grid-connected inverter, since this apparatus is almost reduced to solid-state high frequency switches.

A consequence of using PEM stacks with a high DC output voltage is that the number of cells needed to generate the same power output increases. The disadvantage of having more components, end higher assembly costs is more than balanced by the advantages. The heat generated in the small cells can be removed better, the pressure drop of the gasses in the cells are lower, the reaction water can be removed better, and the cell components are manufactured in lager numbers benefiting from economy of scale effects. However reducing the active area of the cells increases the percentage of ineffective area. Therefore the uses of expensive materials like; the proton conducting membrane, gas diffusion layers and catalyst have to be restricted to the active area.

Use a High DC voltage direct galvanic grid connected fuel cell has surprisingly another advantage; automatic peak shaving. A fuel cell, like a PEM fuel cell has a relatively constant voltage over a wide current range in the high efficiency area of the I-V curve. If a stack is directly connected by the transformer less inverter of this invention to the grid, and the grid voltage decreases, below the nominal voltage, the DC output voltage of the stack decreases also, but the current increases to a larger extent, thus increasing the power output of the stack. This response characteristic will stabilize the grid. If the grid voltage decreases, the power output of the stack and the system will increase, wile at a voltage above the nominal grid voltage the power output will decrease accompanied by an increase of efficiency of the stack.

Although the inverter according this invention has an improved efficiency, some losses still remain. These losses are in general 2-5% of the electrical power, and these losses produce heat. Known grid connected inverters are generally air cooled at a low temperature, and the thermal energy is lost. The inverter according to the invention can be cooled at higher temperature. The heat losses are occurring therefore at a useful temperature, and can be used in the system to increase the water temperature. The inverter has preferably water-cooling, and can be positioned between the cool water outlet of the stack and the hot water storage vessel.

The costs of the control system for an apparatus in general do not have a linear relation with the size, capacity or power of the apparatus. Therefore the relative costs for controls are higher for small systems. Conventional controls are too expensive for small heat and power generation units. The system according to the invention operates at, or close to, atmospheric pressure. The pressure drop over the gas channels remains constant because no droplets are formed, and the capillary drain of this invention removes the water. Because of this constant and uniform pressure drop, the flows can be metered simply by pressure control instead of mass flow control. The ratio between the air that has to flow to reformer and at the air that has to flow trough the stack is controlled by proper design of the flow restrictions in both units. The total flow is simply controlled by controlling the reformer temperature with the voltage of the air fan that blows the air trough the reformer and stack.

1. A combined heat and electrical power generation system comprising at least a fuel cell stack and a reformer characterised in that a high system efficiency is obtained by operating the system at atmospheric pressure or at maximum 300 Pa above atmospheric pressure and the feed gasses are almost saturated with water vapour, leading to water condensation in the cell.

2. An apparatus according to any of the claims characterised in that the fuel cell used is a PEM fuel cell.

3. A fuel cell, characterised in that the water condensed in the fuel cell is removed trough a continuous water film on. the walls of the hydrophilic gas distribution channels, the water film in these gas channels being connected with a water removal channel that runs trough the cell plates and trough the stack and water is removed from the stack trough one ore more of these water removal channels.

4. A fuel cell stack according to any of the preceding claims characterised in that a pressure is applied at the end, or at the ends of the water removal channels, and this applied pressure is below the pressure in the cell.

5. A fuel cell stack according to any of the preceding claims characterised in that the applied pressure on the water removal channel is more than 50 Pa below the pressure in the channels.

6. A fuel cell stack according to any of the preceding claims characterised in that the applied pressure on the water removal channel is between 500 and 1000 Pa below the pressure in the channels.

7. A fuel cell stack according to any of the preceding claims fed by a hydrogen containing gas mixture containing less than 99% hydrogen, characterised in that the pressure drop over the cells in the stack are identical or almost identical, and the pressure drop over de gas channels in the cells of the stack are also identical or almost identical, and the hydrogen utilisation is more than 90%.

8. A fuel cell stack according to claim 7, characterised in that the hydrogen utilisation is more than 95%

9. A combined heat and electrical power generation system comprising at least a fuel cell stack, characterised in that the number of in series connected cells in the stack, or stacks is such that the total DC out-put voltage is above the peak voltage of the AC-grid it is connected with trough an inverter.

10. An apparatus according to claim 9, characterized in that the fuel cell stack is directly, this is without galvanic separation, coupled to the AC-grid trough an inverter without transformer.

11. An apparatus according to claim 9 or 10, characterized in that the DC operating voltage of the fuel cell stack has a direct relation wit the AC grid voltage resulting in increased power generation by the fuel cell stack when the AC grid voltages decreases thus stabilizing the grid

12. An apparatus according to claim 9, 10 or 11, characterized in that the apparatus is switched of if the voltage exceeds a pre determent maximum, or if the voltage falls below a pre determined minimum.

13. A grid connected inverter for the conversion of DC to AC, characterised in that a fuel cell stack generates the DC, and there is no galvanic separation between the stack and the grid.

14. A inverter according to claim 13, characterized in that the DC output voltage of the connected fuel cell stack is more than 1,414214562 times higher than the AC voltage of the grid it is connected with.

15. A inverter according to claim 13 or 14, characterised in that the AC output has no phase shift compared to the grid.

16. An inverter according to claim 13, 14 or 15 characterized in that the operation temperature of the inverter is above the operation temperature of the fuel cell stack.

17. An inverter according to claim 13, 14, 15 or 16 characterized in that the inverter is water cooled, and that the heat is used in the system.

18. A combined heat and electrical power generation system comprising at least a fuel cell stack and a reformer, characterised in that the thermal isolation of the reformer, the preheating of the feed gasses, the cooling of the converted gasses and the CO to CO2 converter are integrated into a single reactor, and the catalyst for the CO to CO2 conversion is in the cooling channel of the converted gasses.

19. An apparatus according to claim 18, characterized in that the integrated reactor and heat exchanger have the shape of spiral with 4 parallel blades.
